(19) United States
(12) Patent Application Publication
(10) Pub. No.: US 2015/0203137 A1
(43) Pub. Date: Jul. 23, 2015

(54) Cart with Movable Cradle

(71) Applicant: Electro Kinetic Technologies, LLC, Germantown, WI (US)

(72) Inventors: Richard John Lang, Oconomowoc, WI (US); Raymond Albert Erbe, Brown Deer, WI (US)

(73) Assignee: ELECTRO KINETIC TECHNOLOGIES, LLC, Germantown, WI (US)

(21) Appl. No.: 14/160,096

(22) Filed: Jan. 21, 2014

(51) Int. Cl. B62B 3/04; B62B 3/02; B62B 5/00; B62B 3/10

(52) U.S. Cl. CPC B62B 3/04; B62B 3/104; B62B 3/02; B62B 5/0053; B62B 5/0069

(57) ABSTRACT

A cart for transporting a portable tank, such as a tank containing fluid and/or gas is disclosed. The cart enables transportation of large heavy tanks by a single user in a highly ergonomic manner. In an embodiment, the cart comprises a cart frame, wheels coupled to the cart frame, a tank-supporting cradle, a first actuator, a retainer, a control system and a power source. The cradle is movably secured with respect to the cart frame and movable by the first actuator between upright and inclined positions. The tank can be easily transported when the cradle is in the inclined position. The retainer captures the tank on the cradle. A second actuator may be provided to operate the retainer to capture the tank. The control system powered by the power source may operate all aspects of the cart including the first and second actuators.

### FIELD

The field relates to carts and, more particularly, to carts with a movable cradle facilitating loading, unloading and transport of heavy objects.

### BACKGROUND

Portable tanks have long been provided for storage, transport and use of industrial fluids. These portable tanks can be filled with fluids such as liquefied nitrogen, oxygen, argon, carbon dioxide, and fluid/gas mixtures. Such portable tanks provide a means by which to transport the fluids from the fluid source to the point of use.

Portable tanks of the type described above are typically elongate with a generally cylindrical shape including a domed first, or upper, end and a flattened second, or bottom, end. Typical portable tanks can have a height, or length, of up to about 69 inches, a diameter of up to about 26 inches and an unfilled weight of up to about 465 pounds. When filled with one or more fluid, such a portable tank can have a weight in excess of 900 pounds.

Portable tanks typically include fixtures on the domed upper end. The fixtures can include one or more valves for filling and/or discharging fluid from the tank and can further include a pressure gauge. These fixtures are typically protected against damage by means of a robust surrounding ring-shaped metal barrier known as a “halo.” The halo is affixed to the domed end of the portable tank and around the fixtures by at least two robust connecting posts. Each connecting post will typically have a slotted opening, or hole, that is provided to receive a securing hook from an overhead hoist or a cart.

Once filled with fluid at the source, the portable tank must be transported to the point of use. Optionally, the portable tank may be stored at a storage location (e.g., a distribution center, a warehouse, the end-user's facility, etc.) intermediate the source and point of use. After use, the empty or partially-filled portable tank is returned to the source, or to a further source, for refilling. The refilled portable tank can then be transported to any storage location or point of use. All of these operations typically require movement of the portable tanks by human users.

Movement of portable tanks of the types described above has typically been accomplished by means of an inclined or upright cart such as illustrated respectively in FIGS. 1 and 2. The portable tank must first be manually loaded by a user onto the inclined or upright cart. Once loaded, the portable tank is typically secured to the inclined or upright cart by means of a hook or chain to prevent shifting of the portable tank. If the cart is not motorized, the cart must then be pushed or pulled by the user to transport the portable tank to the desired location.

Use of inclined or upright carts of the types illustrated in FIGS. 1 and 2 presents important problems from a human factors perspective. A first set of human factors concerns arises during the loading and unloading of the inclined or upright cart. As can be appreciated, a user seeking to load or unload the cart must manipulate both the cart and the large and heavy portable tank. As previously described, a filled portable tank can weigh in excess of 900 pounds. And, an inclined or upright cart can weigh an additional 120 pounds. Handling of such heavy objects presents a risk of injury to any user.

The human factors concerns associated with use of inclined and upright carts can be better appreciated through an explanation of how such carts are utilized. Referring first to FIG. 1 and the inclined cart 1 shown therein, in order to load a portable tank (e.g., tank 111, 111a, 111b FIGS. 3A-3C) onto inclined cart 1, a user must first lift cart handle 3 up to thereby rotate cart 1 frame 5 about front axle 7 and wheels 9 into a position in which frame 5 is just past vertical and caster wheels 11 are on the floor or other surface. Next, the user must maneuver cart 1 using caster wheels 11 to position pickup hook 13 on frame 5 into a portable tank lifting slot such as lifting slot 127 illustrated in FIGS. 3A-3C and 10-11.

Once pickup hook 13 is engaged with the lifting slot, the user must next manually lower handle 3 with the portable tank retained by both pickup hook 13 and frame 5 to thereby rotate cart 1 about front axle 7 and wheels 9. The cart 1 is rotated into an inclined transportation position in which front wheels 9 and rear wheels 15 rest on the floor or other surface and the portable tank is inclined on frame 5. In the process, the weight of the portable tank is shifted onto cart 1. Cart 1 and portable tank can now be pushed and pulled by the user across the floor or other surface. To unload cart 1, the foregoing process is performed in reverse order. FIG. 1 illustrates a Model 60072-64 inclined cart manufactured by Harper Trucks, Inc. of Wichita, Kans.

Referring next to FIG. 2, in order to load a portable tank such as tank 111, 111a, 111b onto an upright cart 17, the user must partially tip the portable tank forward by hand, manually maneuver the cart 17 under the tank using handle 19 while holding the portable tank in the tipped position, and then control the tank as it is allowed to tip back into a vertical position on the frame 21 for transport. Next, the user must secure chain 25 around the portable tank (e.g., tank 111, FIG. 3) to retain the portable tank on frame 21.

As with the inclined cart 1, the weight of the portable tank is shifted onto cart 17 during the loading process. Cart 17 and the portable tank loaded thereon can now be pushed and pulled by the user across the floor surface. To unload cart 17, the foregoing process is performed in reverse order. FIG. 2 illustrates an EZ Load Model 4L cart manufactured by Saf-T-Carts, Inc. of Clarksdale, Miss.

As can be readily appreciated, the actions required by the user to load and unload the inclined or upright cart 1, 17 with the resultant shifting of the cumbersome and heavy portable tank onto the cart exposes the user to potential musculoskeletal-related injuries, along with the potential for severe injuries to fingers and hands.

Further human factors concerns arise during movement of the loaded inclined or upright cart 1, 17. A loaded cart can be very heavy, especially if loaded with a portable tank (e.g., tank 111) with a weight of about 800 pounds. Such weight can require a user to exert push or pull forces to move the cart 1, 17 that exceed safe limits. And, the forces required to be applied by the user increase exponentially when moving the loaded cart 1, 17 on inclined or carpeted surfaces. Application of these push/pull forces by the user is another potential source of musculoskeletal-related injuries to the user's back, shoulders, and legs.

Use of an upright cart 17 can be especially difficult and dangerous on an inclined surface due to the high center of gravity of the load, particularly when the portable tank (e.g., tank 111) is fully filled and at maximum weight. When moving an upright cart 17 up an inclined surface or backing upright cart 17 down an inclined surface, if the portable tank starts to tip rearward toward the user, the high center of gravity quickly shifts beyond the axle of the rear caster wheel 27. Once this shifting of the load occurs, the user will be unable to stop the portable tank and cart 17 from toppling. Righting the portable tank on cart 17 is then virtually impossible, particularly if the portable tank is fully filled with fluid or gas. When the portable tank shifts as described, it is usually necessary to remove chain 25 from around the portable tank and then right the cart 17 and tank on a flat surface, after which the portable tank must again be manually loaded as described above.

A further human factors concern exists when moving upright cart 17 loaded with a portable tank (e.g., tank 111 FIG. 3) down a sloped surface. In such a setting, there is a risk that upright cart 17 could tip forward. Tipping forward of the portable tank can cause the center of gravity of upright cart 17 to shift beyond front wheels 23, toppling the portable tank and upright cart 17. A user could be injured by any such load shifting or toppling of upright cart 17.

Yet another disadvantage of upright carts, such as upright cart 17, is that such upright carts have low ground clearance. The low ground clearance can make it difficult to move upright cart 17 over obstacles on a surface, such as a raised doorway threshold, and over the top of sloped surfaces, such as a lift-gate on a truck.

Another shortcoming of inclined and upright carts 1, 17 is that such carts can lack a braking mechanism to stop and hold the cart 1, 17 in a fixed position on a surface. And, the inertia of a loaded cart can make maneuvering difficult in confined spaces. Loss of control on a sloped surface can result in significant injury to the user and other individuals, as well as substantial property damage to surrounding equipment and facilities.

It would be an advance in the art to provide a cart which would be easy and safe to load, which would be stable, which would reduce risk of user injury and property damage and which would generally have improved performance relative to existing carts.

### SUMMARY

A cart for transporting a portable tank is described herein together with methods of loading a portable tank onto a cart. Embodiments of the cart can be configured to meet some or all of the abovementioned needs as well as other requirements which the user may request.

In an embodiment, a cart comprises a cart frame, wheels or another conveyance device, a tank-supporting cradle, a retainer for the tank, a first actuator, a control system and a power source. The cart frame supports the cart on a surface such as a floor, lift gate, elevator or truck bed. The wheels or other conveyance device may be coupled to the cart frame to enable the cart to be moved across the surface.

In embodiments, the tank-supporting cradle may be movably secured with respect to the cart frame. In certain embodiments, the cradle is pivotally secured to the cart frame. The cradle may be movable with respect to the cart frame between an upright position and an inclined position. In embodiments, the upright position may, for example, be a position of the cradle just past vertical, a position in which the cradle is fully vertical or another position for loading of the tank onto the cart or unloading the tank from the cart. The inclined position may, for example, be a position in which the cradle is inclined with respect to the cart frame for supporting the portable tank during transport of the portable tank or temporary storage of the portable tank on the cart.

In embodiments, the retainer may be mounted on the cradle. The retainer may be movable with respect to the cradle into a position which is aligned with a tank lifting element when the cradle is in the upright position. In the embodiments, the retainer engages the lifting element to load the tank onto the cart when the cradle is moved from the upright position toward the inclined position and disengages the lifting element to unload the tank onto the surface when the cradle is moved from the inclined to the upright position. The tank should be placed on the surface to transfer the weight of the tank to the surface for the unloading to be completed.

In certain embodiments, the first actuator is preferably secured with respect to the cart frame and serves to move the cradle back and forth with respect to the cart frame between the upright and inclined positions.

The control system is provided to control operation of the first actuator and any other components of the cart as desired. A power source is preferably onboard the cart to provide electrical power to the control system, the first actuator and other components as desired. The power source may be one or more battery. An onboard battery charger may be provided for charging of the battery or batteries.

In certain embodiments, the cart frame can be designed to permit pivoting movement of the cradle with respect to the cart frame. In such embodiments, the cart frame can define a cradle pivot axis. The cradle can pivot between the upright and inclined positions with respect to the cart frame about the pivot axis. In various embodiments, the cart frame may include a pair of spaced apart and opposed cradle brackets defining the cradle pivot axis between the brackets. The cradle may have an upper end, a lower end and a pivot rod proximate the cradle lower end pivotally coupled to the cradle brackets along the cradle pivot axis. The pivot rod and cradle brackets support the cradle with respect to the cart frame so that the cradle can pivot between the upright and inclined positions with respect to the cart frame about the pivot axis.

In embodiments, an electro-mechanical linear actuator can be implemented for use as the first actuator although it is envisioned that other types of actuators may be implemented. In an embodiment, the first actuator may include a first component secured with respect to the cradle, a second component secured with respect to the cart frame and the first actuator extends and, alternatively, retracts the first component with respect the second component to move the cradle between the upright and inclined positions. In an embodiment, the first actuator may move the cradle from an upright position just past vertical to the fully upright vertical position to engage the retainer with the lifting element and load the tank on the cart.

A retainer suitable for use with the cart may include a retention element mounted on the cradle. In an embodiment, the retention element is capable of engaging the lifting element of the tank to capture and retain the tank on the cradle. In embodiments, the cradle may include an upper end and a lower end. The retention element may move toward the upper end and, alternatively, toward the lower end to align the retention element with the lifting element. In certain preferred embodiments, the retention element may be provided in the form of a hook and the lifting element may be a portion of the tank adjacent a lifting slot. In such embodiments, the hook can be inserted into the lifting slot to engage a surface of the portable tank adjacent the lifting slot.

In certain embodiments, a second actuator may be provided to act on the retainer to move the retention element into alignment with the lifting element. A second actuator is desirable to align the retention element with the lifting element of the portable tank independent of the position of the cradle thereby providing a greater range of positions for operation of the cart for loading and unloading a portable tank. In such embodiments, the control system can be operated to control the second actuator. The second actuator may be an electro-mechanical linear actuator although it is envisioned that other types of actuators may be implemented. The second actuator may include a first component secured with respect to the retention element and a second component secured with respect to the cradle. The second actuator may extend and, alternatively, retract the first component with respect to the second component to move the retention element toward and away from the upper end of the cradle.

In certain embodiments, a propulsion system may be provided to power movement of the cart on the surface. The propulsion system may include an electric motor in power-transmission relationship with at least one of the wheels. Powering of a single wheel may be sufficient to propel the cart across the surface. The propulsion system can power types of conveyances other than wheels.

A user-accessible control unit can be provided to provide control inputs to the motor and the actuators. It is preferred that the control unit is in a location which is easily accessible, for example on a handle of the cart. A programmable motor controller that controls operation of the propulsion system may be provided.

In still other embodiments, the cart can include a brake which automatically engages and stops movement of the cart on the surface when the motor is not powering the at least one wheel and the cart has come to a complete stop. A control input on the control unit may be provided which enables disengagement of the brake when the cart is completely stopped. Disengagement of the brake allows manual movement of the cart for loading of the tank onto the cart.

Other aspects and examples of the cart and invention are described in the disclosure which follows.

### BRIEF DESCRIPTION OF THE DRAWINGS

Exemplary carts with a movable cradle may be understood by reference to the following description taken in conjunction with the accompanying drawings, in which like reference numerals identify like elements throughout the different views. The drawings are not necessarily to scale, emphasis instead being placed upon illustrating the principles of the invention. The drawings depict only embodiments of the invention and are not therefore to be considered as limiting the scope of the invention. In the accompanying drawings:

FIG. 1 is a perspective view of an inclined manual-type cart;

FIG. 2 is a perspective view of an upright manual-type cart;

FIGS. 3A-3C illustrate embodiments of portable tanks;

FIG. 4 is a perspective view of an embodiment of a cart with a movable cradle according to the invention;

FIG. 5 is a further perspective view of the cart embodiment of FIG. 4;

FIG. 6 is a perspective view of the front underside of the cart embodiment of FIG. 4 showing a transaxle assembly which includes a motor and gearbox;

FIG. 7 is a side elevation view of the cart embodiment of FIG. 4;

FIG. 8 is a perspective view of the rear portion of the cart embodiment of FIG. 4 including a handle and user-accessible control unit;

FIG. 9 is a side elevation view of the cart embodiment of FIG. 4, but with a portable tank being loaded on the movable cradle;

FIG. 10 is a perspective view showing a retainer in a lowered position;

FIG. 11 is a perspective view showing the retainer in a raised position and within a lifting slot during capture and retention of the portable tank;

FIG. 12 is a side elevation view of the cart embodiment of FIG. 4, but showing movement of the movable cradle and portable tank thereon between an upright position and an inclined position;

FIG. 13 is a side elevation view of the cart embodiment of FIG. 4, but with the portable tank loaded on the movable cradle in the inclined position;

FIG. 14 is an enlarged fragmentary side elevation view of the cart of FIG. 13 showing an exemplary retainer engaged with an exemplary connecting post and lifting slot; and

FIGS. 15A-15C illustrate embodiments of hooks capable of use with the cart of FIG. 4.

### DETAILED DESCRIPTION

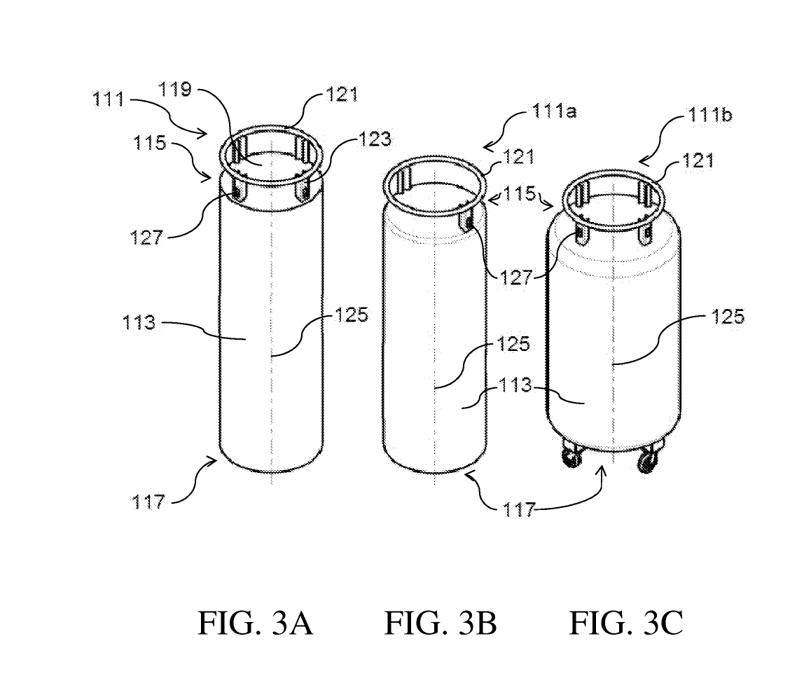

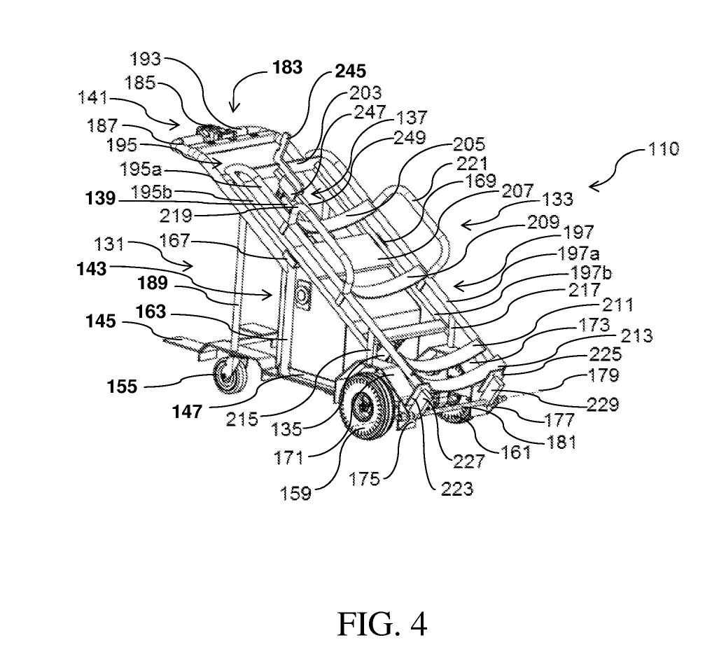

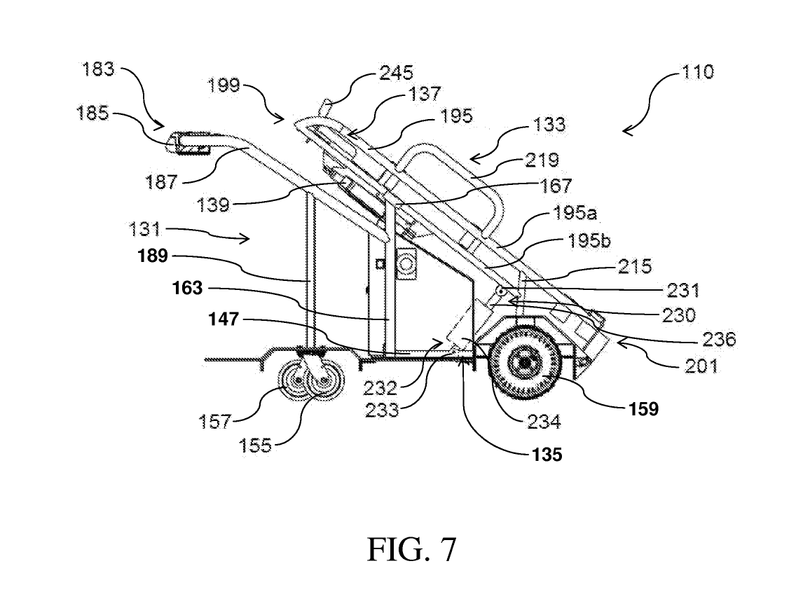

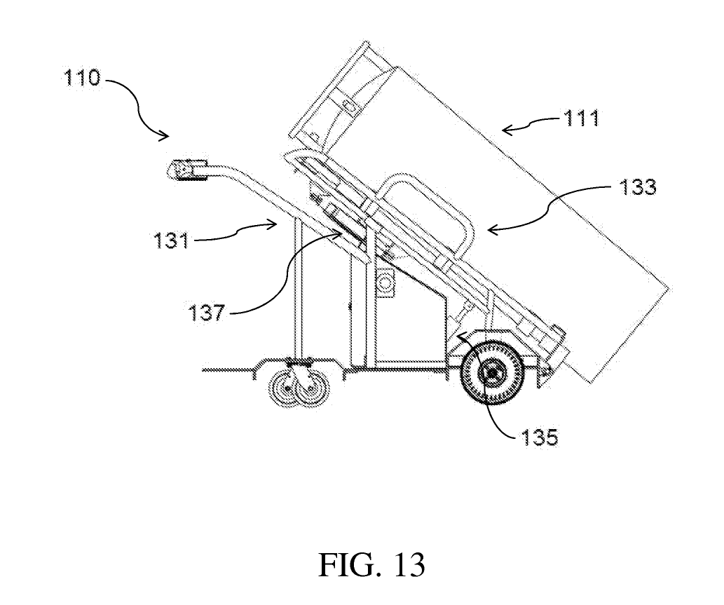

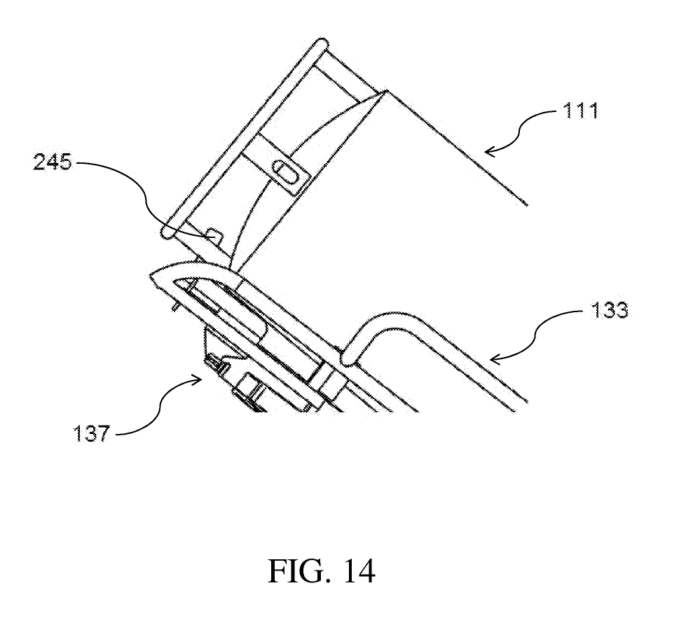

Referring now to FIGS. 4-14, there is shown an embodiment of an exemplary cart with a movable cradle 110, referred to herein simply as a cart. Cart 110 of the example is of a type configured to carry and transport a portable tank, examples of which are indicated by reference numbers 111, 111a, and 111b in FIGS. 3A-3C.

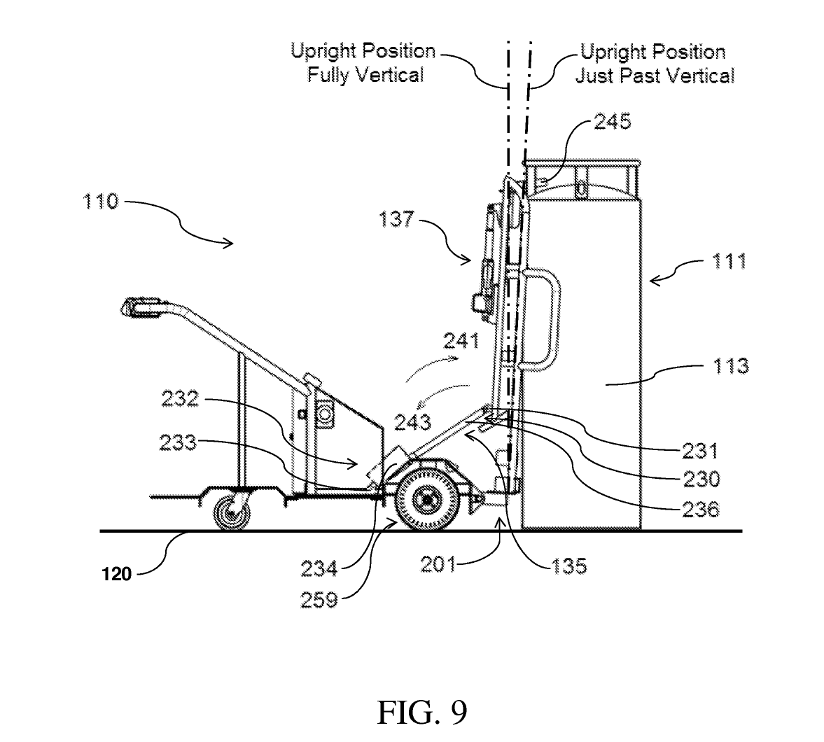

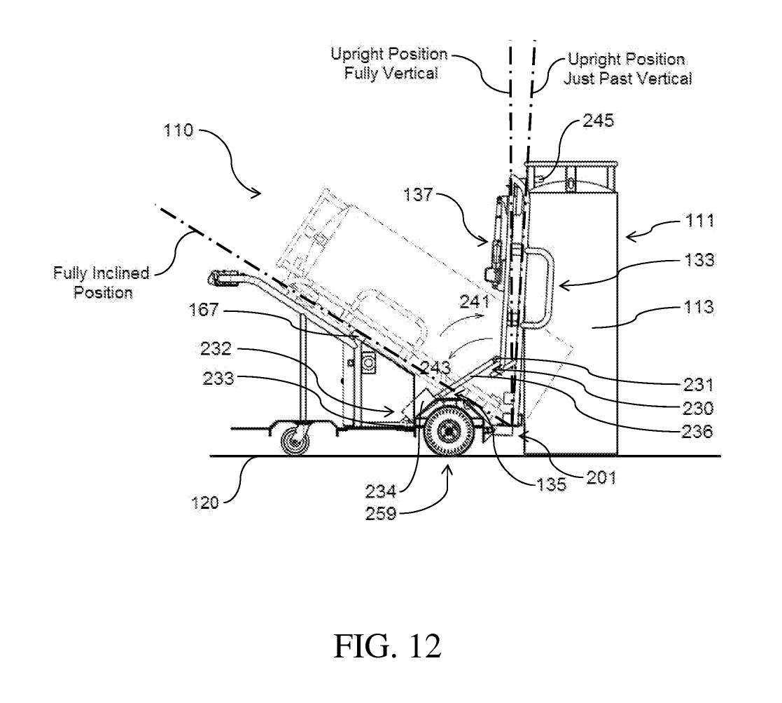

Referring first to FIGS. 3A-3C, an embodiment of a portable tank 111, 111a, 111b capable of being transported on cart 110 can include a body 113, a first or upper end 115, and a second or lower end 117. For convenience and brevity like reference numbers are used for similar parts of portable tanks 111, 111a and 111b. In the example, body 113 is elongate with a generally-cylindrical shape. First end 115 may include a dome 119 and second end 117 may be flattened to enable portable tank 111 to stand upright on a surface 120 (FIGS. 9 and 12), such as a floor, lift gate, elevator or truck bed. Portable tank 111 may be made of various materials with stainless steel being preferred. Portable tank 111 may have a size and weight as described previously, namely a height, or length, dimension of about 58 to about 69 inches, a diameter dimension of up to about 26 inches, and an unfilled weight of up to 465 pounds. Portable tanks 111, 111a, 111b are cumbersome large heavy objects which are difficult for a single person to move.

Portable tanks 111, 111a, 111b can contain a wide range of fluids and gases. For example, a portable tank 111 can contain liquefied nitrogen, oxygen, argon, carbon dioxide or other liquids, gases and mixtures. By way of example only, portable tanks 111, 111a, 111b can contain approximately 160 to 240 liters of a liquid gas at ambient temperature (e.g., 70° F.). When portable tank 111, 111a, 111b is fully filled, it can weigh over 900 pounds.

Referring further to FIGS. 3A-3C, portable tanks 111, 111a, 111b preferably further include a ring-shaped halo 121 mounted onto first end 115 of body 113 by a plurality of connecting posts 123 that connect halo 121 to body 113. Halo 121 can substantially follow an outer perimeter of body 113 and can have a diameter dimension substantially the same as the diameter dimension of body 113 as with portable tanks 111, 111a. In other embodiments of portable tank 111b, halo 121 can have a diameter smaller or greater than the outer perimeter of body 113. Halo 121 can share a common central axis 125 with body 113. In other embodiments, halo 121 can be offset from central axis 125 of body 113. Halo 121 provides a barrier which prevents damage to various fixtures such as filling/discharge valves, fittings and pressure gauges (not shown), affixed to dome 119. Halo 121 further provides a type of grab bar with which the user can manually grasp to manipulate portable tank 111 by leaning or rolling portable tank 111.

In the example of portable tanks 111, 111b, four connecting posts 123 couple halo 121 to body 113. Portable tank 111a has two connecting posts 123. Each connecting post 123 can be provided as a vertical plate. Each connecting post 123 can be welded or otherwise attached to dome 119 and halo 121. Connecting posts 123 are of a robust material such as stainless steel. Referring to FIGS. 3A-3C, each connecting post 123 defines a lifting slot 127. Lifting slot 127 is a slotted opening, or hole. Lifting slot 127 is one type of structure that may be used to secure portable tank 111 to cart 110 as described herein. In the example, each connecting post 123 and its lifting slot 127 each comprise a lifting element. Other lifting element types could be utilized. For example, a lifting element could be knob or a strap extending outward from body 113.

Referring now to FIGS. 4-14, cart 110 embodiment as shown therein includes structure, systems and controls enabling improved loading, unloading and transportation of portable tanks 111 of various types and sizes (e.g., portable tanks 111-111b). In the example, cart 110 generally includes a cart frame 131, a movable tank-supporting cradle 133, a first actuator 135 which controls movement of the tank-supporting cradle 133, a retainer 137 which retains the portable tank 111 to cradle 133, a second actuator 139 which controls movement of the retainer 137, a control system 141 and a power source 143.

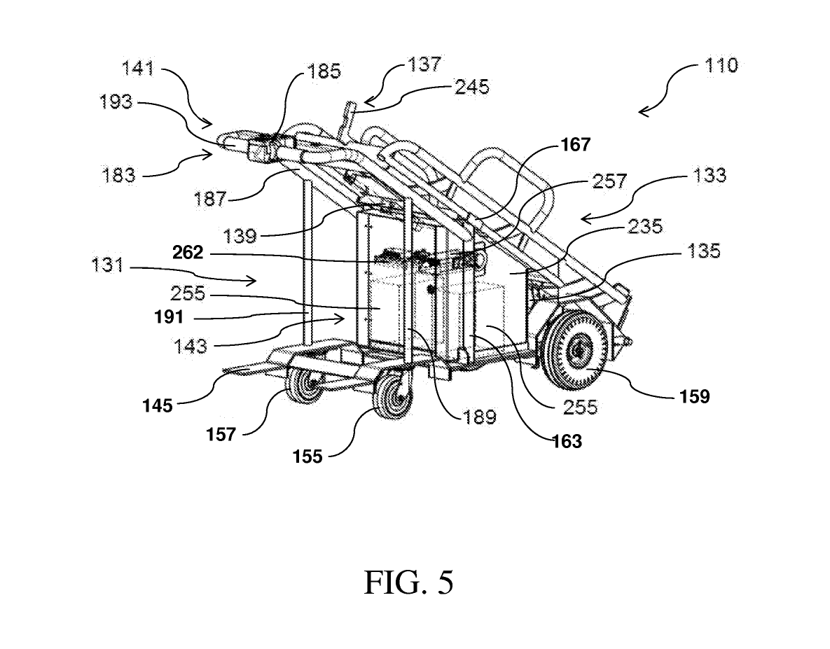

Cart frame 131 will now be described in connection with FIGS. 4-14, it being understood that cart frame 131 is merely an example. In the example, cart frame 131 supports cart 110 on a surface 120. Cart frame 131 includes a platform 145, brace tubes 147, 148 spanning front-to-rear of cart frame 131 and a pair of front and rear cross members 151, 153 joined to platform 145 spanning side-to-side of cart frame 131. In the example, the rear of cart 110 may be thought of as the end of cart 110 nearest a user during portable tank transportation while the front is the end opposite the rear. Platform 145 and front and rear cross members 151, 153 are preferably welded together to form a sturdy structure on which other components of cart frame 131 can be supported. As illustrated in FIG. 5, platform 145 closest to a user during operation of cart 110 can optionally be extended to provide a portion on which a user can stand as a counterweight to offset the weight of portable tank 111 during the portable tank 111 loading and unloading processes.

In the example, wheels 155, 157, 159 and 161 are coupled to cart frame 131 to support cart frame 131 and to permit cart 110 to be moved across a surface 120. In the example, wheels 155 and 157 are caster wheels which rotate 360° to enable steering of cart 110 and the pair of wheels 159 and 161 are drive wheels which are powered to provide propulsion for cart 110 as described herein. Wheels 155, 157, 159, 161 are preferably sized to provide the desired spacing between platform 145 and the surface 120 on which cart 110 is resting so that cart 110 has ground clearance over any obstructions.

Cart frame 131 further includes a pair of uprights 163, 165 attached at a lower end to platform 145 and terminating at an upper end in a support bracket 167, 169 which supports cradle 133 when in the full inclined position illustrated in FIGS. 4-5, 7 and 12-14. As best illustrated in FIGS. 4-5, support brackets 167, 169 preferably have a U-shaped channel into which cradle 133 is received and seated when cradle 133 is in the inclined position. Support brackets 167, 169 limit lateral movement of cradle 133 which is desirable to prevent load shifting of a portable tank 111 during transportation.

Fenders 171, 173 are secured to platform 145 over a respective drive wheel 159, 161 to protect drive wheels 159, 161 from damage caused by contact with obstacles. Fenders 171, 173 also provide a stop surface which partially supports cradle 133 when in the inclined position as described below.

Along front end of cart frame 131 is a mechanism that enables movement of cradle 133 relative to cart frame 131. In the example, such mechanism may include a pair of opposed cradle brackets 175, 177 attached to platform 145 and which define a cradle pivot axis 179 between cradle brackets 175, 177. A cradle pivot rod 181 spans between cradle brackets 175, 177 along pivot axis 179. Cradle 133 is pivotally mounted to cart frame 131 through this mechanism and pivots, or rotates, with respect to cart frame 131 on pivot rod 181 and about axis 179 in the example.

Referring to FIGS. 4-5, 7-9 and 12-13, along rear end of cart frame 131 a handle assembly 183 is provided which a user grasps to push, pull and steer cart 110 and which can support a user-accessible control unit 185 by which the user controls operation of cart 110 as described herein. In the example, handle assembly 183 includes a U-shaped strut 187 secured as a part of cart frame 131 by attachment of strut ends to a respective upright 163, 165 and by attachment of strut 187 at opposite intermediate portions to a respective upright 189, 191. Uprights 189, 191 are attached at a lower end to platform 145. Handle portion 193 is provided for user gripping of handle assembly 183. Handle portion 193 may be covered with a tactile surface to facilitate gripping of handle portion 193.

Platform 145, cross members 151, 153 and cradle brackets 175, 177 are preferably made of ¼ inch plate steel while strut 187 and uprights 163, 165, 189, 191 are preferably made of 1½ inch steel tube stock. Such components of cart frame 131 are preferably welded together to provide a rigid and robust structure which will not deform when pushed, pulled or steered.

Referring now to FIGS. 4-5, 7 and 9-15C, movable tank-supporting cradle 133 is provided to load, secure and unload a portable tank 111 with respect to cart 110. This manipulation of portable tank 111 can occur because tank-supporting cradle 133 moves with respect to cart frame 131 while cart frame 131 remains in place on a surface 120 (e.g., a floor, a truck bed, etc.) to permit securement of portable tank 111 on cart 110 in a manner which minimizes risk of potential musculoskeletal-related and other injuries to the user and damage to property.

In the example, cradle 133 includes a pair of frame rails 195, 197 spanning from a first, or upper, end 199 of cradle 133 to a second, or lower, end 201 of cradle 133. Cross members 203, 205, 207, 209, 211, 213 are joined to a respective frame rail 195, 197 spanning side-to-side of cradle 133. Frame rails 195, 197 may each comprise a first member 195a, 197a and a second member 195b, 197b to provide rigidity. Stop members 215, 217 may be joined to a respective first and second member 195a, 195b or 197a, 197b. Stop members 215, 217 rest against a respective fender 171, 173 to support cradle 133 when cradle 133 is in the inclined position.

In the example, cross members 203, 207 span between second members 195b, 197b and add rigidity to cradle 133. Cross members 203, 207 also serve as a support for retainer 137 and second actuator 139 as described herein. Cross members 205, 209, 211, 213 span between first members 195a, 197a and also add rigidity to cradle 133. Preferably, cross members 205 and 209-213 are provided with a radius which enables cross members 205 and 209-213 to wrap partially around portable tank 111 when portable tank 111 is received by cradle 133 to limit lateral movement of portable tank 111 and to better secure portable tank 111 to cart 110. Lateral restraints 219, 221 extend from first members 195a, 197a to partially wrap around a portable tank 111 to further limit lateral movement of portable tank 111 during loading and when loaded on cradle 133. Lateral restraints 219, 221 also provide a hand hold for a user to grab for pushing or pulling cart 110.

In the example, frame rail 195, 197 first members 195a, 197a terminate in a plate 223, 225, each of which is attached to a respective pivot tube 227, 229. Plates 223, 225 are preferably made of rectangular steel tube stock material. Preferably, each plate 223, 225 is welded to a first member 195a, 197a and each plate 223, 225 is welded to a respective pivot tube 227, 229. Pivot tubes 227, 229 support pivot rod 181 offset from first members 195a, 197a to permit pivoting movement of cradle about pivot rod 181 and pivot axis 179. Pivot rod 181 may be secured in place on cradle brackets 175, 177 using two cotter pins (not shown) placed through holes located on each end of pivot rod 181 outboard of cradle brackets 175, 177.

Cradle 133 may be made of any material or materials known in the art that can support the weight of a typical portable tank 111. Examples are 0.18 inch plate steel, and 1 inch and 1½ inch steel tube stock. Such components of cradle 133 are preferably welded together to provide a rigid and robust structure which will not deform when loaded with a portable tank 111. Cradle support members 195, 197 and cross members 203-213 can be sized to support a portable tank 111 of a desired range of lengths and volumetric sizes. Cradle 133 can optionally include additional components to facilitate loading and unloading. For example, cradle 133 can include a toe or platform along cradle second, or lower, end 201 to support second, or bottom, end 117 of portable tank 111. Cradle 133 can include one or more straps or chains configured to be placed around portable tank 111 body 113 to capture and/or retain portable tank 111 on cradle 133.

Cradle 133 can be mounted with respect to cart frame 131 using mechanisms other than pivot rod 181. For example, cradle 133 could be secured with respect to cart frame 131 by appropriately sized heavy-duty hinges, a scissors mechanism or any other mechanism that is known in the art that can allow cradle 133 to move with respect to cart frame 131 to load, secure and unload portable tank 111 in an ergonomic and stable manner.

A first actuator 135 may be provided to move cradle 133 back and forth with respect to cart frame 131 between the upright and full inclined positions as well as positions intermediate such upright and inclined positions. As used herein, the “upright position” means or refers to a position of cradle 133 wherein cradle 133 is sufficiently upright and in position to load or unload a portable tank 111. In embodiments and as illustrated in FIGS. 9 and 12, the upright position could be a position just past fully vertical or a position which is fully vertical. Other positions of cradle 133 for portable tank 111 loading and unloading are contemplated. The “inclined position” means or refers to a position of cradle 133 in which portable tank 111 is inclined and in position on cart 110 for transportation or temporary storage of cart 110 and portable tank 111 thereon.

In the example and referring to FIGS. 4-5, 7, 9 and 12-13, first actuator 135 may comprise an electro-mechanical linear actuator. First actuator 135 may have a first end 230, pivotally attached to first actuator bracket 231 and a second end 232 pivotally attached to second actuator bracket 233. The attachment points may be, for example, removable clevis pins (not shown) held in place on a respective actuator bracket 231, 233 by cotter pins (not shown) thereby enabling first actuator 135 to be removed from cart 110 for service simply be removing the clevis pin from the respective actuator bracket 231, 233.

First actuator 135 may include a motor 234 and a telescoping piston rod 236 which is driven by motor 234 to extend and, alternatively, retract. Motor 234 is attached to cart frame 131 by means of second cradle actuator bracket 233 and piston rod 236 is attached to cradle 133 by means of first actuator bracket 231. In the example, piston rod 236 serves as a first component of first actuator 135 and motor 234 serves as a second component of first actuator 135. Piston rod 236 moves relative to motor 234 in the example.

Referring to FIGS. 9 and 12, extension of piston rod 236 (the first component) relative to motor 234 (the second component) exerts a push-type force in which piston rod 236 acts on cradle 133 and causes cradle 133 to move with respect to cart frame 131 in the direction of arrow 241. Retraction of piston rod 236 relative to motor 234 exerts a pull-type force which moves cradle 133 in the direction of arrow 243 with respect to cart frame 131. In the example, cradle 133 pivots between (1) an upright position, which may be just past vertical in certain embodiments or fully vertical in other embodiments (FIGS. 9 and 12), for loading and unloading of portable tank 111, (2) the full inclined position (FIGS. 4-5, 7 and 12-14) for transportation or storage of portable tank 111 and (3) positions intermediate the upright and inclined positions as described in more detail herein. Motor 234 of first actuator 135 can be controlled or geared to gradually move cradle 133 between the upright and inclined positions, or could be controlled to move cradle 133 at other speeds. For example it may be beneficial to provide a more rapid movement of cradle 133 when cradle 133 is not supporting a portable tank 111. A Linak Model LA36 actuator from Linak U.S. Inc. of Louisville, Ky. is one example of a type of linear actuator which may be used as a first actuator 135.

First actuator 135 may comprise devices other than an electro-mechanical linear actuator. For example, first actuator 135 could comprise a motor-driven gear mechanism, an electro-mechanical screw-type device, an automatic hydraulic cylinder, an automatic pneumatic cylinder, or any other motorized gearing or sprocket arrangement known to persons of skill in the art.

Referring next to FIGS. 4-5, 7 and 9-14, a retainer 137 and second actuator 139 may be provided to capture and retain portable tank 111 on cradle 133. In the example, retainer 137 comprises a hook 245, together with a hook bracket 247, and a hook track 249. In the example, second actuator 139 powers movement of hook bracket 247 and hook 245 back-and-forth along hook track 249. An advantage of second actuator 139 is that a portable tank 111 can be loaded onto or unloaded from cradle 133 when cradle 133 is upright and past vertical or fully vertical because second actuator permits hook 245 to be brought into contact with portable tank 111 independent of cradle 133 movement in the direction of arrows 241, 243.

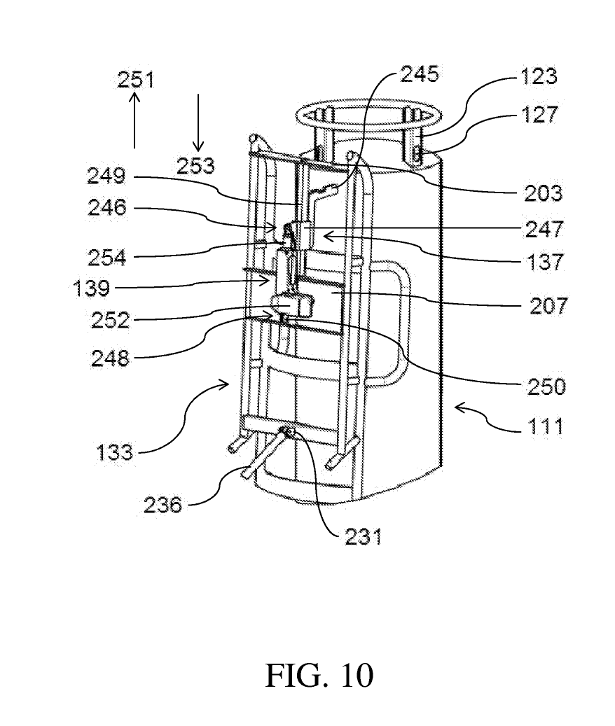

Referring specifically to FIGS. 4 and 9-11, retainer 137 enables a user to capture and, alternatively, to release a portable tank 111 from cradle 133 by automatically positioning hook 245 into, or out of, lifting slot 127 of portable tank 111 to engage connecting post 123 lifting element and portable tank 111. Referring to the example illustrated in FIGS. 9-10, hook 245 is generally axial and has a groove 242 for engaging connecting post 123. Hook 245 faces outward from cradle 133 such that hook 245 exerts a generally upward force on connecting post 123 and portable tank 111 when hook 245 is positioned in lifting slot 127 of portable tank 111 and cradle 133 is rotated in the direction of arrow 243 to shift the weight of portable tank 111 onto cradle 133 and cart 110. Consequently, portable tank 111 is captured and held in position on cart 110 while portable tank 111 is being transported. Reversing the process enables portable tank 111 to be unloaded from cart 110.

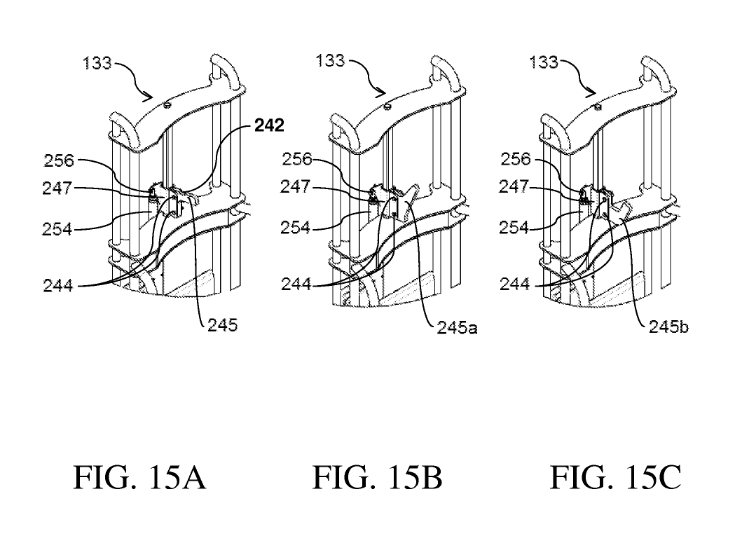

In the example, hook 245 can be removed and interchanged with hooks 245a, 245b as illustrated in FIGS. 15A-15C or other devices capable of capturing portable tank 111. The type of device will be selected to capture the type of lifting element implemented on the particular portable tank. It can be desirable to interchange hooks 245, 245a, 245b, for example, to accommodate capture and retention of portable tanks 111 of various shapes and sizes. Referring to FIGS. 3A-3C, it can be seen that portable tank 111b has a diameter which is greater than portable tanks 111 and 111a and yet all tanks have the same diameter halo 121. Therefore, halo 121 of portable tank 111b is spaced inward relative to tank body 113. To capture portable tank 111b, it may necessary to utilize a relatively longer and axial hook, such as hook 245, which can span between hook bracket 247 and halo 121. Alternatively, a modified version of hooks 245a, 245b with a longer hook capable of spanning between hook bracket 247 and halo 121 could be utilized to engage and capture a portable tank 111b.

Hooks, such as hooks 245a, 245b are relatively shorter and more angular and are quite useful without further modification for capturing portable tanks 111, 111a in which the halo 121 and portable tank 111, 111a diameters are approximately the same. Hooks of an interchangeable type, such as hooks 245, 245a, 245b, can be detachably coupled to hook bracket 247 by removable clevis pins 244. In yet other embodiments where interchangeability is not desired, a hook such as hooks 245, 245a and 245b can be integrally formed with hook bracket 247 as a single unit.

Hook track 249 may be any structure designed to mate with hook bracket 247 and to allow hook bracket 247 to move back-and-forth along hook track 249 alternatively in the directions of arrows 251, 253. For example, hook track 249 could have a male “T-shape” configuration and hook bracket 247 could have a female configuration complementary to hook track 249. Other relationships of hook bracket 247 and hook track 249 may be implemented.

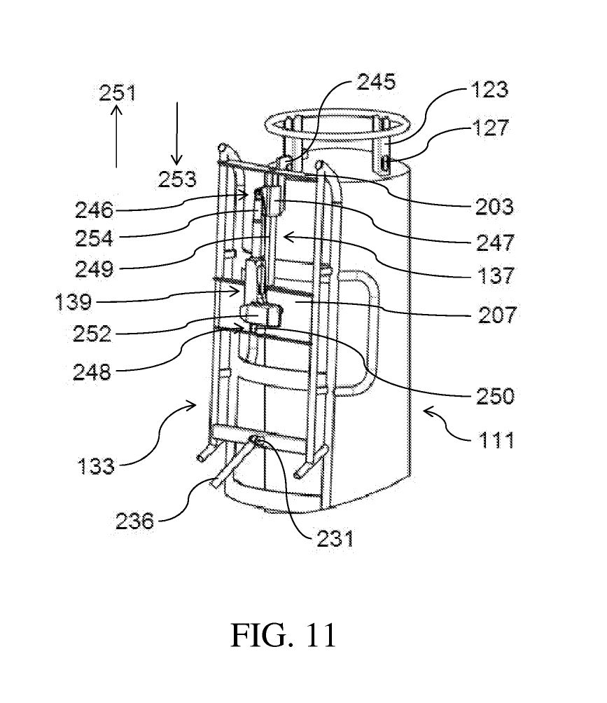

As illustrated in FIGS. 4-5, 7 and 9-14, second actuator 139 may be an electro-mechanical linear actuator. In the example, second actuator 139 is configured to slide hook bracket 247 axially along hook track 249 in either a direction toward cradle 133 first end 199 in the direction of arrow 251 or toward cradle 133 second end 201 in the direction of arrow 253 (FIGS. 10-11). Second actuator 139 may have a first end 246 attached to hook bracket 247 and a second end 248 attached to hook actuator bracket 250. Hook actuator bracket 250 may be secured to cross member 207. The attachment points may be, for example, removable clevis pins such as the clevis pin 256 illustrated in FIGS. 15A-15C. Clevis pins, such as pin 256, may be held in place by cotter pins (not shown) on a respective hook bracket 247 and hook actuator bracket 250 thereby enabling second actuator 139 to be removed from cradle 133 for service simply by removing the clevis pin (e.g., clevis pin 256) from the respective hook bracket 247 and actuator bracket 250.

Second actuator 139 may include a motor 252 and a telescoping piston rod 254 which is driven by motor 252 to extend and, alternatively, retract. In the example, piston rod 254 serves as a first component of second actuator 139 and motor 252 serves as a second component of second actuator 139. Piston rod 254 moves relative to motor 252 in the example. Motor 252 is secured with respect to cradle 133 and piston rod is secured with respect to hook 245 (i.e., a retention element).

Extension and, alternatively, retraction of piston rod 254 (the first component) of second actuator 139 under power of motor 252 (the second component) acts on hook bracket 247 and causes hook 245 of retainer 137 to slide axially back-and-forth in the directions of arrows 251, 253 with respect to cradle 133 for alignment of hook 245 with a lifting element which may be lifting slot 127 and connecting post 123 of portable tank 111 and to engage or release hook 245 from such lifting element. Motor 252 of second actuator 139 can be controlled or geared to gradually move hook bracket 247 into an engaged position (FIGS. 9 and 11-14) with portable tank 111 in which hook 245 is within lifting slot 127 and the groove 242 of hook 245 is snugged against connecting post 123. Motor 252 can also move hook bracket 247 to a position in which hook 245 is disengaged from portable tank 111 (FIG. 10).

Motor 252 can be controlled to move hook bracket 247 at various speeds. For example it may be beneficial to provide a more rapid movement of hook bracket 247 and hook 245 when retainer 137 is being moved into alignment with lifting slot 123 and is not supporting a portable tank 111. A Linak Model LA31 actuator from Linak U.S. Inc. of Louisville, Ky. is one example of a type of linear actuator which may be used as a second actuator 139.

In the example, portable tank 111 is shifted onto cart 110, potentially in several different but related ways. In one embodiment, hook 245 can be aligned with the lifting element (e.g., connecting post and lifting slot 123, 127) by operation of second actuator 139 and engaged with portable tank 111 through movement of cradle 133 in the direction of arrow 243 as illustrated in FIGS. 9 and 12. In the embodiment of FIGS. 9-12, the portable tank 111 loading process is started with cradle 133 at the position indicated Upright Position Just Past Vertical. This position of cradle 133 is angled forward of cart 110.

Hook 245 will initially be spaced from the lifting element comprising connecting post 123 and lifting slot 127 with hook 245 aligned with lifting slot 127. In the example, alignment is accomplished by use of second actuator 139 to move hook 245 up or down along cradle 133. In this embodiment, hook 245 need not be initially snugged against connecting post 123.

Movement of cart 110 forward inserts hook 245 into lifting slot 127 with groove 242 of hook 245 aligned with connecting post 123. Cradle 133 is in the upright position just past vertical. Hook 245 and groove 242 are initially spaced slightly from the connecting post 123 surface at the upper end of lifting slot 127.

Cradle 133 is next moved in the direction of arrow 243, to the position indicted Upright Position Fully Vertical (FIGS. 9 and 12). Such fully vertical position is essentially transverse to surface 120 in the example. As cradle 133 moves toward the fully vertical position, hook 245 will move upwardly in an arc about axis 179 and into contact with connecting post 123 whereupon hook 245 groove 242 becomes seated snugly against connecting post 123. Unpowered movement of cart 110 toward portable tank 111 captured on hook 245 brings cradle 133 parallel to and fully into contact with tank body 113.

As cradle 133 is moved in the direction of arrow 243 from the fully vertical position toward the inclined position, the pulling force applied through hook 245 causes portable tank 111 to tip toward cradle 133 fully engaging hook 245 with tank 111. The tipped portable tank 111 essentially remains at least partially supported by surface 120 until cradle 133 is past the fully vertical position minimizing the force actuator 135 needs to generate to load portable tank 111 onto cart 110. Further movement of cradle 133 in the direction of arrow 243 to the fully inclined position shifts the weight of portable tank 111 onto cradle 133 and frame 131 of cart 110 for transportation.

In a variation of the aforementioned tank loading approach, hook 245 can be engaged with portable tank 111 by operation of second actuator 139 before cradle 133 is moved in the direction of arrow 243. In this variation, cradle 133 is initially in the upright position past vertical (FIGS. 9 and 12) and second actuator 139 is used to raise hook 245 in the direction of arrow 251 into alignment with lifting slot 127. Forward movement of cart 110 inserts hook 245 into lifting slot 127. Second actuator 139 is then used to move hook 245 in the direction of arrow 251 into a position within lifting slot 127 with groove 242 fully snugged against connecting post 123 to engage portable tank 111. Movement of cradle 133 in the direction of arrow 243, to the fully vertical position (FIGS. 9 and 12) causes hook 245 to move upwardly in an arc about axis 179 to lift portable tank 111 onto cradle 133. Portable tank 111 tips toward cradle 133 as cradle 133 moves in the direction of arrow 243 past the full vertical position. In this embodiment, the tipped portable tank 111 is lifted more fully onto cradle 133 as cradle 133 moves to the fully vertical position. The weight of portable tank 111 is shifted fully onto cradle 133 and cart 110 for transportation.

In yet another variation, the tank loading process can be started with cradle 133 in the position indicated Upright Position Fully Vertical (FIGS. 9 and 12) and with cradle 133 parallel to tank body 113. Hook 245 will initially be spaced from connecting post 123, aligned with lifting slot 127. Operation of second actuator 139 to move hook 245 in the direction of arrow 251 or 253 enables the alignment.

Movement of cart 110 forward inserts hook 245 into lifting slot 127 with cradle 133 in the full vertical upright position and moves cradle 133 into contact with tank body 113. Hook 245 is initially spaced slightly from the connecting post 123 surface at the upper end of lifting slot 127.

Second actuator 139 is used to move hook 245 in the direction of arrow 251 whereupon groove 242 of hook 245 is snugged against connecting post 123 of portable tank 111. The pulling force applied through hook 245 caused by movement of cradle 133 in the direction of arrow 243 past the full vertical position toward the inclined position causes portable tank 111 to tip toward cradle 133 fully engaging hook 245 with portable tank 111. Cradle 133 and portable tank 111 are then moved to the fully inclined position by further movement of cradle 133 in the direction of arrow 243. The weight of portable tank 111 is shifted fully onto cradle 133 and cart 110 for transportation.

All of the aforementioned variations are made possible because second actuator 139 enables movement of hook 245 independent of cradle 133.

Second actuator 139 may comprise devices other than an electro-mechanical linear actuator. For example, second actuator 139 could comprise a motor-driven gear mechanism, an electro-mechanical screw-type device, an automatic hydraulic cylinder, an automatic pneumatic cylinder, a manual or motorized winch, a manual or motorized rack and pinion, a ratchet device or any other motorized or manual gearing or sprocket arrangement known to persons of skill in the art.

In still other embodiments, retainer 137 hook 245 can be configured to move in a non-linear direction along a non-linear track 249. By way of example, hook 245 can move in an arcuate path towards and/or away from lifting slot 127 of a portable tank 111 positioned adjacent cradle 133.

In yet other embodiments, cart 110 may be provided without a second actuator 139. In such embodiments, hook 245 (or hooks 245a, 245b) may be manually set at one of several positions relative to first end 199 of cradle 133. For example, hook bracket 247 with hook 245 thereon could be modified for axial manual sliding along hook track 249 and could be set in place along hook track 249 by means of a removable clevis pin or other fastener. In such embodiment, hook 245 is in a fixed position relative to cradle 133 for capturing portable tank 111. The user must manually set the hook 245 position based on alignment of hook 245-245b with lifting slot 127 of the connecting post 123 lifting element in the same manner as illustrated, for example, in FIG. 11.

Because hook 245 (or hooks 245a, 245b) is not movable relative to cradle 133 once set in place on cradle 133, cart 110 should be loaded with cradle 133 initially in the upright position past vertical as illustrated in FIGS. 9 and 12. Hook 245 will initially be spaced from connecting post 123 and aligned with lifting slot 123. Forward movement of cart 110 inserts hook 245 into lifting slot 127. Hook 245 is initially spaced slightly from the connecting post 123 surface at the upper end of lifting slot 127.

Movement of cradle 133 in the direction of arrow 243, to the fully vertical position, causes hook 245 to move upwardly in an arc about axis 179 and become seated snugly against connecting post 123 fully engaging hook 245 with portable tank 111. Movement of cart 110 toward portable tank 111 captured on hook 245 brings cradle 133 parallel to and fully into contact with tank body 113. The pulling force applied through hook 245 caused by movement of cradle 133 from the fully upright position further in the direction of arrow 243 causes portable tank 111 to tip toward cradle 133. Cradle 133 and portable tank 111 are then moved to the fully inclined position by further movement of cradle 133 in the direction of arrow 243. The weight of portable tank 111 is shifted fully onto cradle 133 and cart 110 for transportation.

While not preferred, it is also possible to provide an embodiment in which retainer 137 does not move with respect to cradle 133. By way of example only hook 245 could be located in a single fixed position with respect to cradle 133. Such an embodiment would function in the same manner as the manually-adjustable hook embodiment described previously and would be useful for moving portable tanks 111 of the same size and with the same type of lifting element (e.g., the same type of connecting post 123 and lifting slot 127).

Referring to FIGS. 4-7 and 12-13, a power source 143 may be provided onboard cart 110 to supply electrical power to the first and second actuators 135, 139, control system 141, optional propulsion system 259 and other components requiring electrical power. In the example, power source 143 comprises one or more battery collectively indicated by 255. Battery or batteries 255 may be enclosed in electrical enclosure 235. Power source 143 preferably comprises two 12-volt DC batteries 255, but any battery, combination of batteries, or other power source 143 can be used. Battery 255 (or batteries) is preferably rechargeable. In the example, an onboard battery charger 257 provides a charging connection between battery 255 and an external electrical power source. In another embodiment, an onboard connection providing a charging connection between battery 255 and a battery charger remote from cart 110 may be provided. In certain embodiments in which first and second actuators 135, 139 are mechanical, pneumatic, or hydraulic (not shown), a battery-type onboard power source 143 may not be required for powering of those types of first and second actuators 135, 139.

Referring next to FIGS. 4-7 and 12-13, cart 110 may optionally include a drive, or propulsion, system 259 to power movement of cart 110 across a level surface 120 or a sloped surface. Implementation of a propulsion system 259 is extremely desirable from a human factors perspective because the risk of potential musculoskeletal-related injuries to the user may be reduced by lessening the need to push and pull cart 110. Propulsion system 259 is not required because cart 110 can be manually pushed and pulled by the user.

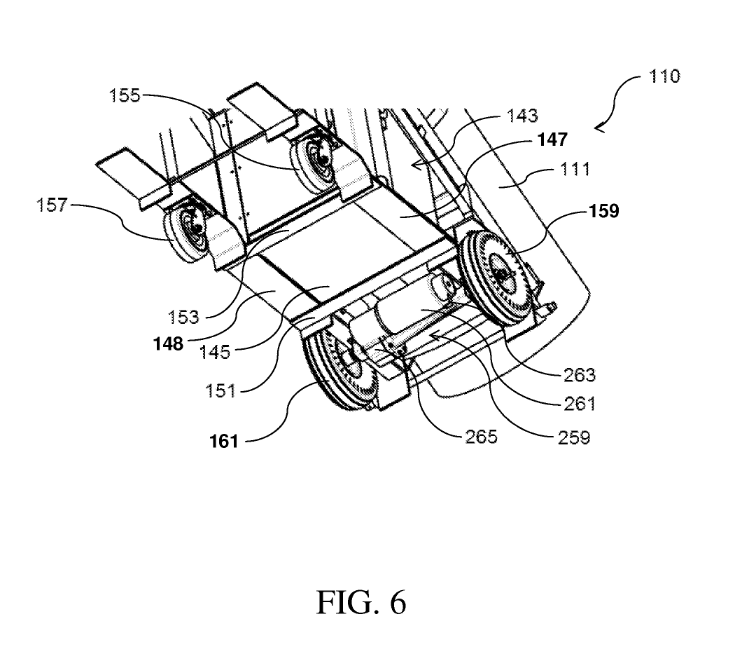

Referring to FIGS. 5-6, propulsion system 259 may comprise a transaxle device consisting of a motor 261, motor controller 262, brake 263, and a gearbox 265 which power drive wheels 159, 161. It is not required that two wheels 159, 161 are driven. In embodiments, one wheel or all wheels could be driven. Other conveyance devices such as rollers, tracks and combinations of conveyance devices could be substituted for wheels 155, 157, 159, 161. Power source 143 provides electrical power to motor 261, motor controller 262 and brake 263.

Propulsion system 259 can be configured to provide dynamic braking in which a braking force is applied to drive wheels 159, 161 when motor 261 is not powering drive wheels 159, 161 or when the speed of cart 110 exceeds a predetermined maximum safe speed. As already noted, propulsion system 259 can be configured to include a brake 263 that can be operated by motor controller 262 to lock drive wheels 159, 161 to prevent rotation when motor 261 is not powering drive wheels 159, 161 and cart 110 has come to a complete stop. By way of example, motor controller 262 can be programmed to cause brake 263 to automatically engage (1) whenever throttle 267 is at a zero-speed setting and cart 110 has come to a complete stop or (2) whenever motor 261 is not receiving power from power source 143 and cart 110 has come to a complete stop. Throttle 267 can also be configured to include an automatic safety feature that biases throttle 267 to return to a zero-speed position (i.e., a stopped position) if the user's thumb or other finger is removed from throttle 267. Brake 263 can also be electronically disengaged using a separate brake switch 279 which disengages brake 263 to allow cart 110 to be pushed without operation of propulsion system 259 to facilitate loading or unloading of portable tank 111 as discussed herein.

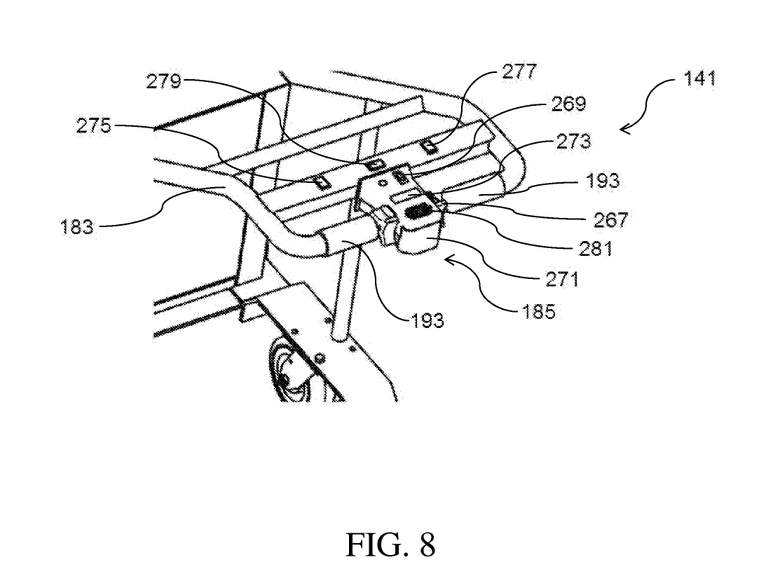

Referring to FIG. 8, a user-accessible control system 141 including a user interface unit 185, a cradle control switch 275 (which controls first actuator 135 and operation of cradle 133), a retainer control switch 277 (which controls operation of second actuator 139 and operation of retainer 137), and a brake switch 279 all mounted on handle assembly 183 is provided to control operation of cart 110. In the example, control system 141 controls first and second actuators 135, 139, power source 143 and optional propulsion system 259.

Referring again to FIG. 8, user interface unit 185 of control system 141 may include the following control inputs operable by a user: a thumb-wheel throttle assembly control 267, a speed range switch 269 (e.g., dual speed—fast and slow speeds), an emergency stop pad 271, and a horn button 273. User interface unit 185 may also include a power source indicator 281 to provide information to the user regarding an onboard power source (i.e., battery 255). Control inputs from throttle control 267, speed range switch 269, stop pad 271 and brake switch 279, and potentially other inputs, are input to motor controller 262 which controls propulsion system 259 based on those user inputs.

Referring further to FIG. 8, cradle control switch 275 is preferably located in close proximity to thumb-wheel throttle assembly 267. Cradle control switch 275 may, for example, be a momentary “center off type” rocker switch with cradle 133 stop (i.e., center off)/down/up positions. Cradle control switch 275 is configured to generate a control input in the form of an electrical signal to operate first actuator 135 to lower or raise cradle 133 in the example.

Release of cradle control switch 275 opens the switch (i.e., the center off position) and stops operation of first actuator 135 with cradle 133 in any position between the upright position (upright past vertical or fully vertical in the examples FIGS. 9-12) and the full inclined position (FIGS. 4-5, 7 and 12-14).

Pressing and holding of cradle control switch 275 in the down position closes the switch and causes first actuator 135 to act on cradle 133 and to move cradle to the full inclined position of FIGS. 4-5, 7 and 12-14. In the example, first actuator 135 may include a built-in limit switch (not shown) that automatically stops operation first actuator 135 when cradle 133 reaches the full inclined position of FIGS. 4-5, 7 and 12-14. Cart 110 and a portable container 111 loaded thereon may be safely transported in this inclined position of cradle 133.

Pressing and holding of cradle control switch 275 in the up position causes first actuator 135 to act on cradle 133 and to move cradle 133 to an upright position such as illustrated in FIGS. 9-12. Releasing cradle control switch 275 would stop movement of cradle 133 at any position between the upright and inclined positions, including a position in which cradle 133 is in the full vertical position. In the example, first actuator 135 limit switch described previously automatically stops operation of first actuator 135 when cradle 133 reaches an upright position of FIGS. 9-12. Cart 110 is in position to capture a portable container 111 when cradle is in either the full vertical position or the upright position of cradle 133 just past vertical (FIGS. 9-12).

Once cradle 133 is in the upright position of FIGS. 9-12, the user can operate retainer control switch 277 to control retainer 137 to align hook 245 with the portable tank 111 lifting element for purposes of automatically capturing a portable tank 111 on cradle 133 and to unload the portable tank 111. Automatic capture and, alternatively, release of a portable tank 111 by means of a retainer control switch 277 spaced from cradle 133 and retainer 137 is very desirable from a human factors perspective. This is because the user is not required to touch hook 245 with the user's hand to position hook 245 into or out of lifting slot 127 of portable tank 111. This positioning is instead accomplished by automatic movement of retainer 137. The automatic movement of retainer 137 is performed with the user's hand on control system 141 at a safe distance from portable tank 111, cradle 133 and hook 245, thereby avoiding any risk of pinching injury to the user.

In the example, retainer control switch 277 can, for example, be a momentary “center off type” rocker switch with retainer 137 stop (i.e., center off)/down/up positions. Retainer control switch 277 is configured to generate a control input in the form of an electrical signal to actuate second actuator 139 to move hook 245 in the direction of arrows 251, 253 in the example. Pressing and holding of retainer control switch 277 in the down position closes the switch and causes second actuator 139 to act on retainer 137 and to move hook 245 in the direction of arrow 253 toward the full down position illustrated in FIG. 10 and pressing and holding retainer control switch 277 in the up position moves hook in the direction of arrow 251 toward the edge of connecting post 123 along lifting slot 127 as illustrated in FIG. 11, which may be a full up position.

Release of retainer control switch 277 opens the switch (i.e., the center off position) and stops operation of second actuator 139 with hook 245 of retainer 137 in any position between the position toward connecting post 123 edge along lifting slot 127 (FIGS. 9 and 11-14) and the full down position (FIG. 10) of hook 245. In embodiments, portable tank 111 can be unloaded by moving hook 245 sufficiently in the direction of arrow 253 to disengage the lifting element of portable tank 111. In the example, second actuator 139 may include a built-in end limit switch (not shown) that automatically stops operation of second actuator 139 when hook 245 of retainer 137 reaches the full up or down positions.

Movement of hook 245 in the direction of arrow 251 or 253 allows alignment of hook 245 with the lifting element of portable tank 111, such as connecting post 123 and lifting slot 127. Hook 245 is thereby made to be in the correct position to insert hook 245 into lifting slot 127 with hook initially spaced from connecting post 123 of portable tank 111. Retainer control switch 277 would be unnecessary in embodiments in which hook 245 is manually adjustable as described previously.

Once hook 245 is inserted into lifting slot 127, movement of hook 245 in the direction of arrow 251 (FIGS. 9 and 11-14) snugs hook 245 against connecting post 123 in which lifting slot 127 is located if that snugging is desired by the user. Cradle 133 can then be pivoted back past vertical to the full inclined position to lift and then shift the load of portable container 111 onto cradle support members 195, 197 and cradle cross members 203-213 for a more even distribution of weight on cart 110 as described in more detail below.

In addition to manually-operated retainer control switch 277, a sensor such as a current sensing resistor (not shown), can be provided to cause second actuator 139 to stop hook 245 of retainer 137 from moving upward in the direction of arrow 251 when hook 245 within lifting slot 127 has snugly engaged connecting post 123. An increase in current would indicate that hook 245 has reached a predetermined location, is bearing a predetermined amount of weight, or has satisfied any other indication that identifies that hook 245 has reached a location sufficient to capture and/or retain portable tank 111.

It is contemplated that retainers 137 other than as described previously can be implemented consistent with the invention. For example, retainer 137 can be adapted to capture and retain portable tank 111 by means of any structure on portable tank 111 that permits retainer 137 to stably capture portable tank 111 and retain portable tank 111 against cradle 133. It can thus be appreciated that one or more surface defining a lifting slot on 127 portable tank 111, or any other suitable structure that is known in the art, can serve as an attachment point for retainer 137 to capture and retain portable tank 111. It is contemplated that retainer 137 can be configured to function with lifting locations of any size, shape, and location associated with portable container 111.

Referring again to FIG. 8, a brake switch 279 is mounted on handle assembly 183. Brake switch 279 may, for example, be a maintained rocker switch with brake 263 on/off positions. Brake switch 279 is configured to generate a control input in the form of an electrical signal delivered to motor controller 262 to engage (“on”) or disengage (“off”) brake 263 in the example.

Positioning of brake switch 279 in the on position closes the switch causing brake 263 to be engaged thereby locking drive wheels 159, 161 to prevent rotation when motor 261 is not powering drive wheels 159, 161 and the cart 110 has come to a complete stop.

Positioning of brake switch 279 in the off position opens the switch causing brake 263 to be disengaged allowing drive wheels 159, 161 to rotate freely so that the cart 110 can be manually pushed by a user without operation of propulsion system 259. The manual pushing of cart 110 is used, for example, during the portable tank 111 loading and unloading processes to bring cart 110 toward and away from portable tank 111 on surface 120.

Operation of the cart 110 embodiment illustrated in FIGS. 4-14 will now be described in connection with those figures. Referring first to FIGS. 4-8, cart 110 is initially unloaded with cradle 133 pivoted with respect to cart frame 131 in the direction of arrow 243 and in the full inclined position (FIGS. 4-5, 7 and 12-14). Cradle support members 195b, 197b are seated in a respective support bracket 167, 169 and cradle stop members 215, 217 are resting on a respective fender 171, 173 distributing the load of cradle 133 into cart frame 131.

Referring next to FIGS. 9-12, a user next captures portable tank 111 with cart 110. Capture of the portable tank 111 can be accomplished in several ways. The user first maneuvers cart 110 next to an upright portable tank 111 with cradle 133 second, or lower, end 201 proximate body 113 of portable tank 111. Cart 110 may be maneuvered using propulsion system 259, by manually pushing cart 110 if a propulsion system 259 is not provided or by manually moving (e.g., pushing) cart 110 once brake switch 279 is operated to enable drive wheels 159, 161 to rotate freely. If a propulsion system 259 is provided, the user preferably first places cart 110 in the slower of the power settings by providing a control input with speed range switch 269. The user then provides a further control input through thumb-wheel throttle assembly control 267 causing motor 261 to power drive wheels 159, 161 toward portable tank 111. Steering is provided by pushing handle assembly 183 to turn caster wheels 155, 157 and cart 110.

Referring to FIGS. 9 and 12, cradle 133 is moved relative to cart frame 131 in the direction of arrow 241 to an upright position which may be just past vertical or fully vertical in the example of FIGS. 9-12. A fully vertical position of cradle 133 may be implemented for use with a generally axial hook, such as hook 245, if a second actuator 139 is provided to raise and lower hook 245 relative to portable tank 111. Cart frame 131 with wheels 155-161 rests on surface 120 supporting cart 110 while cradle 133 is movable relative to cart frame 131 in the example.

To move cradle 133, the user provides a control input through cradle control switch 275 by pressing and holding the switch in the up position. In the example, motor 224 powers piston rod 226 of first actuator 135. A pushing force applied by piston rod 226 of first actuator 135 against cradle bracket 231 of cradle 133 causes cradle 133 to gradually pivot with respect to cart frame 131 about pivot axis 179 in the direction of arrow 241 from the inclined position, through the intermediate positions and to the upright position just past vertical or the full vertical position, both illustrated in FIGS. 9 and 12.

Next, the user maneuvers cart 110 so that hook 245 of retainer 139 is aligned with lifting slot 127 as illustrated in FIGS. 10-11. Alignment is accomplished by user operation of retainer control switch 277 to raise or lower hook 245 in one of the directions of arrows 251, 253 and into alignment with lifting slot 127. The user then maneuvers cart 110 to guide hook 245 into lifting slot 127. Cart 110 may be maneuvered using propulsion system 259, or by positioning the brake switch 279 in the off position and manually pushing cart 110 toward portable tank 111.

For embodiments in which loading occurs with cradle 133 initially in the position past vertical, the user has the choice of where to position hook 245 relative to portable tank 111. The user may insert the aligned hook 245 into lifting slot 127 and then snug hook against connecting post 123. Or, the user may leave hook 245 spaced from connecting post 123. Spacing hook 245 from connecting post is preferred if it is desired to minimize the force actuator 135 needs to generate to load portable tank 111 onto cart 110.

The user then disengages brake 263 with brake switch 279 and then provides a further control input through cradle control switch 277 by pressing and holding cradle control switch 277 in the down position. The pulling force applied by piston rod 226 of first actuator 135 against cradle actuator bracket 231 causes cradle 133 to gradually pivot with respect to cart frame 131 about pivot axis 179 in the direction of arrow 243. Movement of cradle 133 relative to cart frame 131 in the direction of arrow 243 to the fully vertical position raises hook 245 as hook 245 travels in an arc about axis 179 so that grove 242 is snugged into contact with connecting post 123 thereby engaging the connecting post 123 lifting element to engage and capture portable tank 111 on cradle 133. As cradle 133 moves from just past vertical to the fully vertical position, cart 110 moves toward portable tank 111 captured on hook 245 bringing cradle 133 parallel to and fully into contact with tank body 113.

In embodiments with a manually-adjusted hook 245 (or hooks 245a, 245b), the user sets the position of hook 245 on cradle 133 so that hook 245 is in alignment with lifting slot of portable tank 111. In such embodiments, cradle 133 is initially upright just past vertical. Cart 110 is then maneuvered toward portable tank 111 to insert hook 245 through lifting slot 127. Movement of cradle 133 relative to cart frame 131 in the direction of arrow 243 to the fully vertical position raises hook 245 as hook 245 travels in an arc about axis 179 so that grove 242 is snugged into contact with connecting post 123 lifting element to engage and capture portable tank 111 on cradle 133. Cart 110 moves toward portable tank 111 captured on hook 245 bringing cradle 133 parallel to and fully into contact with tank body 113.

For each of the aforementioned embodiments, as cradle 133 initially moves from the fully vertical position toward the inclined position, movement of cradle 133 applies a pulling force through hook 245 which causes portable tank 111 to tip toward cradle 133.

In other embodiments, cradle 133 could initially be positioned in the full vertical position (FIGS. 9 and 12) and second actuator 139 is used to move hook 245 and align hook 245 with lifting slot 127. After inserting hook 245 into lifting slot 127 which brings cradle 133 fully into contact with tank body 113, second actuator 139 is then used to move hook 245 in the direction of arrow 251 so that groove 242 engages connecting post 123 edge of lifting slot 127. Cradle 133 movement from the full vertical position in the direction of arrow 243 tips portable tank 111 which is then captured on cradle 133.

Brake 263 is then engaged manually using brake switch 279 to stop movement of cart frame 131 on the surface 120. This completes the capture of portable tank 111.

Next, cradle 133 is moved to the fully inclined position illustrated in FIGS. 4-5, 7 and 12-14 to complete the loading process. To accomplish this, the user provides a control input through cradle control switch 275 by pressing and holding the cradle control switch 279 in the down position. In the example, motor 224 retracts piston rod 226 of first actuator 135. The pulling force applied by piston rod 226 of first actuator 135 against cradle actuator bracket 233 causes cradle 133 to again gradually pivot with respect to cart frame 131 about pivot axis 179 in the direction of arrow 243. As cradle 133 initially moves from the fully vertical position toward the inclined position, movement of cradle 133 applies a pulling force through hook 245 which causes portable tank 111 to tip toward cradle 133. Movement of cradle 133 relative to cart frame 131 continues until cradle 133 is in the full inclined position. A limit switch may automatically stop first actuator 135 when cradle 133 is in the fully inclined position. Cradle support members 195b, 197b are once again seated in a respective support bracket 167, 169 and cradle stop members 215, 217 are once again resting on a respective fender 171, 173 distributing the load of cradle 133 and portable tank 111 retained thereto to cart frame 131.

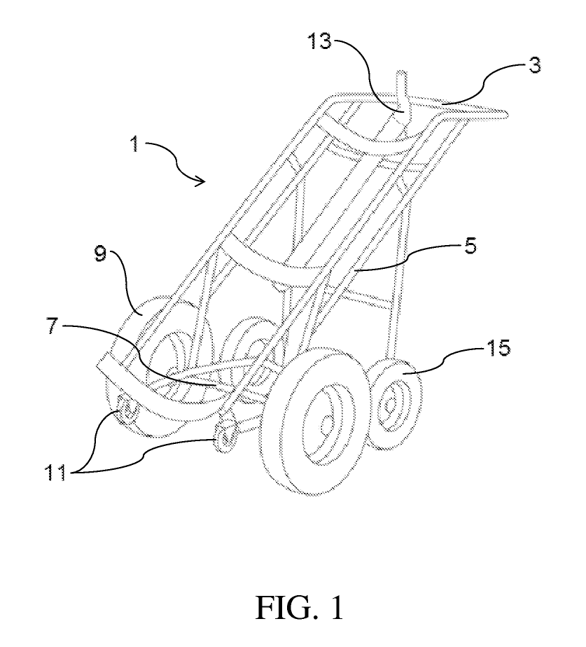

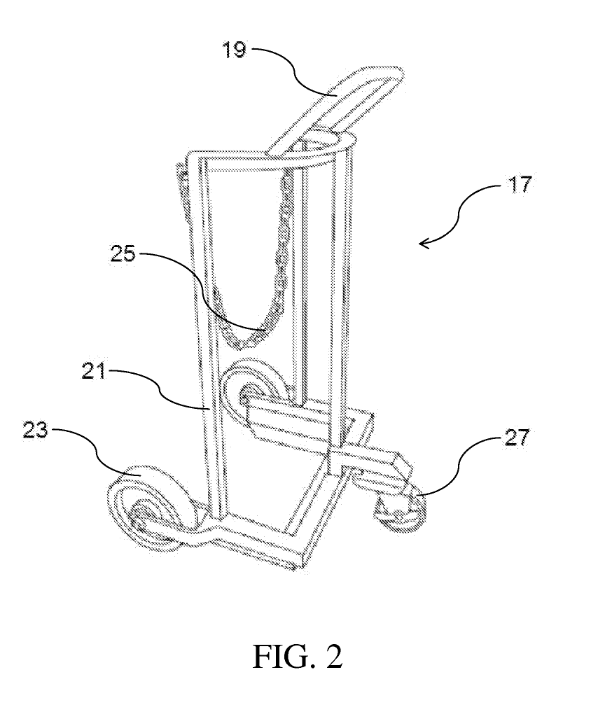

An advantage of movement of cradle 133 relative to cart frame 131 is that the user is freed from having to manipulate tank 111 onto cart 110 which is a requirement of the inclined and upright carts 1, 17 (FIGS. 1-2). This, in turn, reduces the risk of possible injury to the user when using a cart such as cart 110.

Cart 110 and the portable tank 111 secured thereon can now be moved to the desired location. The user may place cart 110 in the desired power setting by providing a control input with speed range switch 269. The user may then provide a further control input through thumb-wheel throttle assembly control 267 causing motor 261 to power drive wheels 159, 161 so that cart 110 can be easily steered to the desired location by user pushing against handle assembly 183. Operation of throttle 267 causes motor controller 262 to automatically release brake 263.

As shown in FIG. 8, a user can control the propulsion system 259 by actuating the thumb-wheel throttle 267 such that the user can actuate the throttle 267 with a thumb while not removing either hand from handle portion 190. Throttle 267 preferably provides an automatic safety feature that biases throttle 267 to return to the zero-speed position if the user's thumb or other finger is removed from throttle 267.

To unload portable tank 111 from cart 110, the user merely performs the abovementioned steps in reverse order.

Cart 110 empowers a single user to easily load, unload and transport large cumbersome and heavy portable tanks 111 and other things in an ergonomic manner with minimal lifting and pushing/pulling and with the user's body spaced from parts that could pinch or crush thereby lessening risk of injury to the user. The structure and operation of the cart 110 effectively secures the portable tank 111 and large objects thereto for efficient transportation with minimized risk of damage which could result if the tank or other object were to separate from the cart 110 or if the cart 110 were to tip over.

The foregoing description is provided for the purpose of explanation and is not to be construed as limiting the invention. While the invention has been described with reference to preferred embodiments or preferred methods, it is understood that the words which have been used herein are words of description and illustration, rather than words of limitation. Furthermore, although the invention has been described herein with reference to particular structure, methods, and embodiments, the invention is not intended to be limited to the particulars disclosed herein, as the invention extends to all structures, methods and uses that are within the scope of the appended claims. The disclosed cart 110 may address some or all of the problems previously described. A particular embodiment need not address all of the problems described, and the claimed cart 110 should not be limited to embodiments comprising solutions to all of these problems. Further, several advantages have been described that flow from the structure and methods; the present invention is not limited to structure and methods that encompass any or all of these advantages. Those skilled in the relevant art, having the benefit of the teachings of this specification, may effect numerous modifications to the invention as described herein, and changes can be made without departing from the scope and spirit of the invention as defined by the appended claims. Furthermore, any features of one described embodiment can be applicable to the other embodiments described herein.

What is claimed is:

1. A cart for transporting a portable tank, the cart comprising:
a cart frame for supporting the cart on a surface;
wheels coupled to the cart frame;
a tank-supporting cradle movably secured with respect to the cart frame and movable between (1) an upright position in which the cradle is upright with respect to the cart frame and in position for loading of the tank onto the cart and unloading of the tank from the cart, and (2) an inclined position in which the cradle is inclined with respect to the cart frame for supporting the tank during transport;
a retainer mounted on the cradle and movable with respect to the cradle into a position which is aligned with a tank lifting element when the cradle is in the upright position to (1) engage the lifting element and load the tank onto the cart when the cradle is moved from the upright position toward the inclined position and (2) disengage the lifting element and unload the tank onto the surface when the cradle is moved from the inclined to the upright position and the tank is on the surface;
a first actuator secured with respect to the cart frame and acting on the cradle to move the cradle back and forth with respect to the cart frame between the upright and inclined positions;
a control system operative to control the first actuator; and
a power source onboard the cart which provides electrical power to the control system and the first actuator.

2. The cart of claim 1, wherein the cradle is pivotally secured to the cart frame.

3. The cart of claim 2, wherein:
the cart frame defines a cradle pivot axis; and
the cradle pivots between the upright and inclined positions with respect to the cart frame about the pivot axis.

4. The cart of claim 3, wherein:
the cart frame includes a pair of spaced apart and opposed cradle brackets defining the cradle pivot axis therebetween; and
the cradle has an upper end, a lower end and a pivot rod proximate the cradle lower end pivotally coupled to the cradle brackets along the cradle pivot axis such that the pivot rod and cradle brackets support the cradle with respect to the cart frame and so that the cradle pivots between the upright and inclined positions with respect to the cart frame about the pivot axis.

5. The cart of claim 1, wherein the first actuator is an electro-mechanical linear actuator.

6. The cart of claim 5, wherein the first actuator includes:
a first component secured with respect to the cradle;
a second component secured with respect to the cart frame; and
the first actuator extends and, alternatively, retracts the first component with respect second component to move the cradle between the upright and inclined positions.

7. The cart of claim 6 wherein the upright position is an upright position just past vertical and the first actuator moves the cradle from the position just past vertical to a fully vertical position thereby engaging the retainer with the lifting element and loading the tank on the cart.

8. The cart of claim 1, wherein the retainer comprises a retention element mounted on the cradle capable of engaging the lifting element of the tank to capture and retain the tank on the cradle.

9. The cart of claim 8, wherein:
the cradle includes an upper end and a lower end; and
the retention element moves toward the upper end and, alternatively, toward the lower end to align the retention element with the lifting element.

10. The cart of claim 9, wherein the retention element is a hook and the lifting element is a portion of the tank adjacent a lifting slot.

11. The cart of claim 9, further including:
a second actuator which acts on the retainer to move the retention element into alignment with the lifting element; and
the control system is operative to control the second actuator.

12. The cart of claim 11, wherein the second actuator is an electro-mechanical linear actuator.

13. The cart of claim 12, wherein the second actuator includes:
a first component secured with respect to the retention element;
a second component secured with respect to the cradle; and
the second actuator extends and, alternatively, retracts the first component with respect second component to move the retention element toward and away from the upper end of the cradle.

14. The cart of claim 10, further comprising a propulsion system powering movement of the cart on the surface.

15. The cart of claim 14, wherein the propulsion system includes an electric motor in power-transmission relationship with at least one of the wheels.

16. The cart of claim 14, further comprising a user-accessible control unit on a cart handle operable to provide control inputs to the motor and the actuators.

17. The cart of claim 16, further comprising a programmable motor controller that controls operation of the propulsion system.

18. The cart of claim 16, further comprising:
a brake which automatically engages and stops movement of the cart on the surface when the motor is not powering the at least one wheel and the cart has come to a complete stop; and
a control input on the control unit which enables disengagement of the brake allowing manual movement of the cart by a user for loading of the tank onto the cart.

19. The cart of claim 16, wherein the power source includes at least one battery.

20. The cart of claim 19, further comprising an onboard battery charger.
